(19) United States
(12) Patent Application Publication
(10) Pub. No.: US 2018/0189708 A1
(43) Pub. Date: Jul. 5, 2018

(54) GOALS SERVICE WITH DATA MODEL

(71) Applicant: Dropbox, Inc., San Francisco, CA (US)

(72) Inventor: Shashank Senapaty, San Francisco, CA (US)

(21) Appl. No.: 15/436,994

(22) Filed: Feb. 20, 2017

Related U.S. Application Data
(60) Provisional application No. 62/440,620, filed on Dec. 30, 2016.

(51) Int. Cl. G06Q 10/06

(52) U.S. Cl. CPC G06Q 10/06393

(57) ABSTRACT

The present technology provides a goals service for creating goals and milestones, and managing them. In some embodiments, the goals service can be associated with a data model that requires milestone to be attached to goals, and allows goals to be linked to larger goals in an organization. Additionally, the data model can require that at least one user account is associated with every milestone, and can detect when a milestone is without an associated user account (e.g., due to team member leaving the team, etc.), and either automatically create an assignment or prompt other user accounts to designate a new user account to assign the milestone to. Additionally, in some embodiments goals service can link milestones and goals to other services within a content management system.

### CROSS REFERENCE TO RELATED APPLICATIONS

This application claims the benefit of U.S. provisional application No. 62/440,620, filed on Dec. 30, 2016, which is expressly incorporated by reference herein in its entirety.

### BACKGROUND

It is common within an organization or within a team to have goals and milestones towards achieving the goals. Sometimes goals and milestones are known as objectives and key results, respectively. However, all too often, employees or team members are given a project without being given an understanding of how their project fits in the bigger picture—how their project helps the company be successful.

### BRIEF DESCRIPTION OF THE DRAWINGS

The above-recited and other advantages and features of the present technology will become apparent by reference to specific implementations illustrated in the appended drawings. A person of ordinary skill in the art will understand that these drawings only show some examples of the present technology and would not limit the scope of the present technology to these examples. Furthermore, the skilled artisan will appreciate the principles of the present technology as described and explained with additional specificity and detail through the use of the accompanying drawings in which:

FIG. 1 shows an example of a content management system and client devices;

FIG. 2 shows another example of a content management system and client devices;

FIG. 3 shows an example goals tree;

FIG. 4 shows an example method embodiment for enforcing a goals data model;

FIG. 5A shows an example method embodiment for maintaining the integrity of the data model;

FIG. 5B shows another example method embodiment for maintaining the integrity of the data model;

FIG. 6 shows an example method for associating a content item with a goal or milestone;

FIG. 7 shows an example method for communicating with user accounts associated with a goal or milestone;

FIG. 8 shows an example “My Goals View” graphical user interface;

FIG. 9 shows an example “Company Goals View” graphical user interface;

FIG. 10 shows an example task list graphical user interface; and

FIG. 11 shows an example of a system for implementing certain aspects of the present technology.

### DETAILED DESCRIPTION

Various examples of the present technology are discussed in detail below. While specific implementations are discussed, it should be understood that this is done for illustration purposes only. A person skilled in the relevant art will recognize that other components and configurations may be used without parting from the spirit and scope of the present technology.

The disclosed technology addresses the need in the art for a service to create team goals and milestones that effectively show how the team goals and milestones fit into the larger organizational context. Too often employees or team members are assigned a project without an understanding of the context of their specific project. Management literature shows that team members will perform better when they see value in their work, and understand how their work benefits a larger organization. Additionally, goals and milestones can be difficult to manage given the dynamic nature of teams. Team members come and go, get promoted, or get reassigned. This can make project management with respect to specific milestone difficult.

The above identified problems can be ameliorated through the use of the present technology, which provides a goals service for creating goals and milestones, and managing them. In some embodiments, the goals service can be associated with a data model that requires milestone to be attached to goals, and allows goals to be linked to larger goals in an organization. Additionally, the data model can require that at least one user account is associated with every milestone, and can detect when a milestone is without an associated user account (e.g., due to team member leaving the team, etc.), and either automatically create an assignment or prompt other user accounts to designate a new user account to assign the milestone to. Additionally, in some embodiments goals service can link milestones and goals to other services within a content management system.

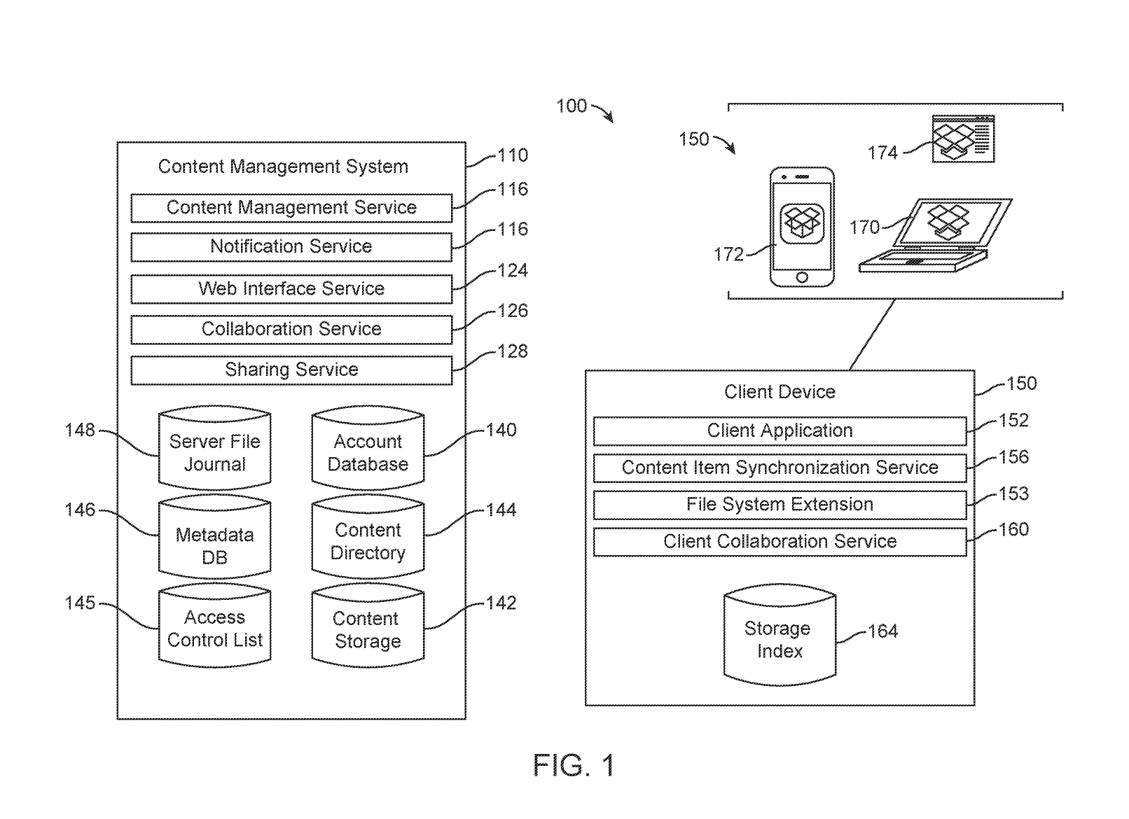

In some embodiments the disclosed technology is deployed in the context of a content management system having content item synchronization capabilities and collaboration features, among others. An example of a system configuration 100 is shown in FIG. 1, which includes content management system 110 interacting with client device 150.

Accounts

Content management system 110 can store content items in association with accounts, as well as perform a variety of content item management tasks, such as retrieve, modify, browse, and/or share the content item(s). Furthermore, content management system 110 can enable an account to access content item(s) from multiple client devices.

Content management system 110 supports a plurality of accounts. An entity (user, group of users, company, etc.) can create an account with content management system, and account details can be stored in account database 140. Account database 140 can store profile information for registered entities. In some cases, profile information for a registered entity can include a username and/or email address. Account database 140 can include account management information, such as account type (e.g., various tiers of free or paid accounts), storage space allocated, storage space used, client devices 150 having a registered content management client application 152 resident thereon, security settings, personal configuration settings, etc.

Account database 140 can store groups of accounts associated with an entity. Groups can have permissions based on group policies and/or access control lists, and members of a group can inherit the permissions. For example, a marketing group can have access to one set of content items while an engineering group can have access to another set of content items. An administrator of a group can modify groups, modify user accounts, etc.

Content Item Storage

A feature of content management system 110 is the storage of content items, which can be stored in content storage 142. As used herein, content items can be any digital data such as documents, collaborative content items, text files, audio files, image files, video files, webpages, executable files, binary files, etc. A content item can also include collections or other mechanisms for grouping content items together with different behaviors, such as folders, zip files, playlists, albums, etc. A collection can refer to a folder, or a plurality of content items that are related or grouped by a common attribute. In some embodiments, content storage 142 can be combined with other types of storage or databases to handle specific functions. Content storage 142 can store content items, while metadata regarding the content items can be stored in metadata database 146. Likewise, data regarding where a content item is stored in content storage 142 can be stored in content directory 144. Additionally, data regarding changes, access, etc. can be stored in server file journal 148. Each of the various storages/databases such as content storage 142, content directory 144, server file journal 148, and metadata database 146 can be comprised of more than one such storage or database and can be distributed over many devices and locations. Other configurations are also possible. For example, data from content storage 142, content directory 144, server file journal 148, and/or metadata database 146 may be combined into one or more content storages or databases or further segmented into additional content storages or databases. Thus, content management system 110 may include more or less storages and/or databases than shown in FIG. 1.

In some embodiments, content storage 142 is associated with at least one content management service 116, which includes software or other processor executable instructions for managing the storage of content items including, but not limited to, receiving content items for storage, preparing content items for storage, selecting a storage location for the content item, retrieving content items from storage, etc. In some embodiments, content management service 116 can divide a content item into smaller blocks of data for storage at content storage 142. The location of each data block making up a content item can be recorded in content directory 144. Content directory 144 can include a content entry for each content item stored in content storage 142. The content entry can be associated with a unique ID, which identifies a content item.

In some embodiments, the unique ID, which identifies a content item in content directory 144, can be derived from a deterministic hash function. This method of deriving a unique ID for a content item can recognize content item duplicates as such since the deterministic hash function will generally output the same identifier for every copy of the same content item, but will output a different identifier for a different content item. Using this methodology, content management service 116 can output a unique ID for each content item.

Content management service 116 can also designate or record a content path for a content item. The content path can include the name of the content item and/or folder hierarchy associated with the content item. For example, the content path can include a folder or path of folders in which the content item is stored in a local file system on a client device. Content management service 116 can use the content path to present the content items in the appropriate folder hierarchy, such as a tree-like directory structure. While content items are stored in content storage 142 in blocks and may not be stored under a tree like directory structure, such directory structure is a comfortable navigation structure for users Content management service 116 can define or record a content path for a content item wherein the “root” node of a directory structure can be a namespace for each account. Within the namespace can be a directory structure defined by a user of an account and/or content management service 116. Content directory 144 can store the content path for each content item as part of a content entry.

In some embodiments the namespace can include additional namespaces that appear in the directory structure as if they are stored within the root node. This can occur when an account has access to a shared collection. Shared collections can be assigned their own namespace within content management system 110. While shared collections are actually a root node for the shared collection, they are located subordinate to the user account namespace in the directory structure, and can appear as a folder within a folder for the user account. As addressed above, the directory structure can be a comfortable navigation structure for users, but does not necessarily correlate to storage locations of content items in content storage 142.

While the directory structure in which an account views content items does not necessarily correlate to storage locations at content management system 110, the directory structure can generally correlate to storage locations on client device 150 depending on the file system used by client device 150.

As addressed above, a content entry in content directory 144 can also include the location of each block of data making up a content item. More specifically, the content entry can include content pointers that identify the location in content storage 142 of the data blocks that make up the content item.

In addition to a content path and content pointer, a content entry in content directory 144 can also include a user account identifier that identifies the user account that has access to the content item and/or a group identifier that identifies a group with access to the content item. In some embodiments, multiple user account identifiers can be associated with a single content entry indicating that the content item has shared access by the multiple user accounts. In some embodiments, user account identifiers associated with a single content entry can specify different permissions for the associated content item. In some embodiments, content directory 144 can describe a hierarchical structure of content items associated with a user account, the hierarchical structure being specific to the user account.

Content management service 116 can decrease the amount of storage space required by identifying duplicate content items or duplicate blocks that make up a content item or versions of a content item. Instead of storing multiple copies, content storage 142 can store a single copy of the content item or block of the content item and content directory 144 can include a pointer or other mechanism to link the duplicates to the single copy.

Content management service 116 can also store metadata describing content items, content item types, folders, file path, and/or the relationship of content items to various accounts, collections, or groups in metadata database 146, in association with the unique ID of the content item.

Content management service 116 can also store a log of data regarding changes, access, etc. in server file journal 148. Server file journal 148 can include the unique ID of the content item and a description of the change or access action along with a time stamp or version number and any other relevant data. Server file journal 148 can also include pointers to blocks affected by the change or content item access. Content management service can provide the ability to undo operations, by using a content item version control service that tracks changes to content items, different versions of content items (including diverging version trees), and a change history that can be acquired from the server file journal 148. The change history can include a set of changes that, when applied to the original content item version, produces the changed content item version.

Content Item Synchronization

Another feature of content management system 110 is synchronization of content items with at least one client device 150. Client device(s) can take different forms and have different capabilities. For example, client device 170 is a computing device having a local file system accessible by multiple applications executing on the device. Client device 172 is a computing device in which content items may only be accessible to a specific application or by permission given by the specific application, and the content items can be stored in an application specific space and/or in a remote network. Client device 174 is any client device accessing content management system 110 via a web browser and accessing content items via a web interface. While example client devices 170, 172, and 174 are depicted in form factors such as a laptop, mobile device, or web browser, it should be understood that these descriptions do not limit clients devices to these form factors. For example, a mobile device, such as client device 172, may have a local file system accessible by multiple applications executing on the device, or client device 172 may access content management system 110 via a web browser. As such, the form factor should not be considered limiting when considering client device 150′s capabilities. One or more functions described in this disclosure with respect to client device 150 may or may not be available on every client device depending on the specific capabilities of the device—the file access model being one such capability.

In many embodiments, client devices are associated with an account of content management system 110, but in some embodiments client devices can access content using shared links and do not require an account.

As noted above, some client devices can access content management system 110 using a web browser. However, client devices can also access content management system 110 using client application 152 stored and running on client device 150. Client application 152 can include a content item synchronization service 156.

Content item synchronization service 156 can be in communication with content management service 116 to synchronize changes to content items between client device 150 and content management system 110.

Client device 150 can synchronize content with content management system 110 via content synchronization service 156. The synchronization can be platform agnostic. That is, content can be synchronized across multiple client devices of varying types, capabilities, operating systems, etc. Content synchronization service 156 can synchronize any changes (new, deleted, modified, copied, or moved content items) to content items in a designated location of a file system of client device 150.

Content items can be synchronized from client device 150 to content management system 110, and vice versa. In embodiments in which client device 150 initiates synchronization of content items with content management system 110, a user can manipulate content items directly from the file system of client device 150, while file system extension 156 (which can be integrated with the local file system, or even the operating system kernel) can intercept read, write, copy, move, delete commands relative to content items in the designated location of the file system of client device 150.

When file system extension 156 detects a write, move, copy, or delete command, it can notify content item synchronization service 156, which can synchronize the changes to content management system service 116. In some embodiments, content item synchronization service 156 can perform some functions of content management system service 116 including functions addressed above such as dividing a content item into blocks, hashing the content item to generate a unique identifier, etc. Content synchronization service 156 can index content within client storage index 164 and save the result in storage index 164. Indexing can include creating a unique identifier for each content item. In some embodiments, content synchronization service 156 creates this unique identifier by putting the data of the content item (e.g., excluding the filename and/or other metadata) through a hash function; as addressed above, content management system can use a similar process to provide identifiers to content on content management system 110. Content synchronization service 156 can use storage index 164 to facilitate the synchronization of at least a portion of the content within client storage with content associated with a user account on content management system 110. For example, content synchronization service 156 can compare storage index 164 with content management system 110 and detect differences between content on client storage and content associated with a user account on content management system 110. Content synchronization service 156 can then attempt to reconcile differences by uploading, downloading, modifying, and/or deleting content on client storage as appropriate. Content management service 116 can store the changed or new block for the content item and update server file journal 148, metadata database 146, content directory 144, content storage 142, account database 140, etc., as appropriate.

When synchronizing content from content management system 110 to client device 150, a modification, addition, deletion, and/or move of a content item recorded in server file journal 148 can trigger delivery of a notification to client device 150 using notification service 117. When client device 150 receives the notification of the change to server file journal 148, client device 150 can check storage index 164 to determine if the time stamp of the change occurred since the last synchronization, or determine if the specific change has been synchronized. When client device 150 determines that it is out of synchronization with content management system 110, content item synchronization service 156 can request content item blocks including the changes, and client device 150 can update its local copy of the changed content items. In some embodiments, notification service 117 can query other services or databases of content management system 110, such as server file journal 148, to gain more context for the notification, to determine if a notification can be batched with another notification, or to supplement a notification, etc.

Sometimes client device 150 might not have a network connection available. In this scenario, content item synchronization service 156 can monitor the linked collection for content item changes and queue those changes for later synchronization to content management system 110 when a network connection is available. Similarly, a user can manually start, stop, pause, or resume synchronization with content management system 110.

Content item synchronization service 156 can synchronize all content associated with a particular user account on content management system 110. Alternatively, content item synchronization service 156 can selectively synchronize a portion of the content of the total content associated with the particular user account on content management system 110. Selectively synchronizing only a portion of the content can preserve space on client device 150 and improve performance of client device 150 and content management system 110 by reducing the processing, memory, storage, and network resources that would otherwise be consumed by synchronizing all content.

In some embodiments, content item synchronization service 156 selectively stores a portion of the content associated with the particular user account and stores placeholder content items in client storage for the remainder portion of the content. For example, content item synchronization service 156 can store a placeholder content item that has the same filename, path, extension, metadata, of its respective complete content item on content management system 110, but lacking the data of the complete content item. The placeholder content item can be a few kilobytes or less in size while the respective complete content item might be significantly larger. After client device 150 attempts to access the content item, content item synchronization service 156 can retrieve the data of the content item from content management system 110 and provide the complete content item to accessing client device 150. This approach can provide significant space and bandwidth savings while still providing full access to a user's content on content management system 110.

Collaboration Features

Another feature of content management system 110 is to facilitate collaboration between users. Collaboration features include content item sharing, commenting on content items, co-working on content items, instant messaging, providing presence and seen state information regarding content items, etc.

Sharing

Content management system 110 can manage sharing of content via sharing service 128. Accounts of content management system 110 can share content with one another by providing a link to the content. Sharing service 128 can then provide access to the shared content item from any computing device in network communication with content management system 110. However, in some embodiments, a link can be associated with access restrictions enforced by content management system 110. Sharing service 128 can also facilitate indirect sharing of content within content management system 110 by enabling an account to share shared content with at least one additional user account (in addition to the original user account associated with the content item) so that each user account has access to the content item. The additional user account can gain access to the content by accepting the content, which will then be accessible through web interface service 124 or the directory structure associated with the additional user's account on client device 150. The sharing can be performed in a platform agnostic manner. That is, the content can be shared across multiple client devices 150 of varying types, capabilities, operating systems, etc. The content can also be shared across varying types of user accounts.

To share a content item within content management system 110, sharing service 128 can add a user account identifier to a content entry in access control list database 145 associated with the content item, thus granting the added user account access to the content item. Sharing service 128 can also remove user account identifiers from a content entry to restrict a user account's access to the content item. Sharing service 128 can record content item identifiers, user account identifiers given access to a content item, and access levels in access control list database 145.

To share content items outside of content management system 110, sharing service 128 may generate a custom network address, such as a uniform resource locator (URL), which can allow any web browser to access the content item or collection in content management system 110 without authentication. To accomplish this, sharing service 128 can include content identification data in the generated URL, which can later be used to properly identify and return the requested content item. For example, sharing service 128 can include the account identifier and the content path or a content item identifying code in the generated URL. Upon selection of the URL, the content identification data included in the URL can be transmitted to content management system 110. Content management system 110 can then use the received content identification data to identify the appropriate content item and return the content item.

In addition to generating the URL, sharing service 128 can also record the URL, or that the URL exists, in access control list database 145. In some embodiments, the content entry associated with a content item can include a URL flag indicating whether a URL to the content item has been created. For example, the URL flag can be a Boolean value initially set to 0 or false to indicate that a URL to the content item has not been created. Sharing service 128 can change the value of the flag to 1 or true after generating a URL to the content item.

In some embodiments, sharing service 128 can associate a set of permissions to a URL for a content item. For example, if a user attempts to access the content item via the URL, sharing service 128 can provide a limited set of permissions for the content item. Examples of limited permissions include restrictions that the user cannot download the content item, save the content item, copy the content item, modify the content item, etc. In some embodiments, limited permissions include restrictions that only permit a content item to be accessed from with a specified domain, e.g., from within a corporate network domain.

In some embodiments, sharing service 128 can also deactivate a generated URL or otherwise unshare a content item. For example, each content entry can also include an active sharing flag indicating whether the content is still shared, and sharing service 128 may only return a requested content item if the active sharing flag is set to 1 or true. Thus, access to a previously shared content item can be restricted by changing the value of the active sharing flag. This can allow a user to restrict access to the shared content item without having to move the content item, delete the generated URL, etc. Likewise, sharing service 128 can reactivate sharing by again changing the value of the active sharing flag to 1 or true. A user can thus easily restore access to the content item without the need to generate a new sharing mechanism, e.g., a new URL.

In some embodiments, content management system 110 can designate a location, such as a URL, for uploading a content item. For example, a first user account can request an upload location from sharing service 128, and provide the upload location to a second user account (or other user in some cases). The second user account or other user can upload a content item to the first user account using the upload location.

Monitoring Interactions with Shared Content Items

In some embodiments, content management system 110 can provide information about user interactions with a shared content item. In some embodiments, content management system 110 can report that a user is currently viewing the shared content item. For example, client collaboration service 160 can request notifications service 117 to send notifications to other client devices having access to the shared content item when any one client device accesses the shared content item. Notifications service 117 can then notify all client devices regarding access to the shared content item by the one client device. In some embodiments, the interaction data can also serve as a proxy for the presence of a user owning and/or operating the one client device.

In some embodiments, content management system 110 can report a history of user interactions with a shared content item. Collaboration service 126 can query data sources such as metadata database 146 and server file journal 148 to determine that a user account has saved the content item, that a user account has yet to access the content item, etc., and disseminate this information using notification service 117 to other user accounts to determine which user accounts have (or have not) interacted with the shared content item.

In some embodiments, collaboration service 126 can facilitate commenting associated with content, even if a content item does not natively support commenting functionality. Such comments can be stored in metadata database 146.

In some embodiments, collaboration service 126 can originate and transmit notifications for users. For example, a first user can mention a second user in a comment and collaboration service 126 can send a notification to the second user that he has been mentioned in the comment. Various other content item events can trigger notifications, including deleting a content item, sharing a content item, etc.

In general, collaboration service 126 can provide a messaging platform whereby users can send and receive instant messages, voice calls, emails, etc.

Collaboration Content Items

Collaboration service 126 can also provide an interactive content item collaboration platform in which users can simultaneously make changes to collaboration content items, provide comments regarding the collaboration content items, manage tasks associated with the collaboration content items, etc. These collaboration content items can be files that user accounts can create and edit using a content item editor, and can contain elements for enabling collaboration. These collaboration elements may include a collaboration identifier, one or more author and/or editor identifiers, collaboration text, collaboration attributes, interaction information, comments, sharing users, etc. The collaboration elements can be stored in a database entity to allow for search and retrieval of the collaboration content items. Multiple user accounts may access, view, edit, and otherwise collaborate on collaboration content items at the same time or at different times. In some embodiments, this can be managed through a web interface that enables two users to work on the same copy of a collaboration content item at the same time.

Collaboration Companion Interface

In some embodiments client collaboration service 160 can provide a native application companion interface for the purpose of displaying information relevant to a content item being presented on client device 150. In some embodiments, a certain content item is accessed by a native application stored and executed on client device 150, where the content item is in a designated location of the file system of client device 150 such that the content item is managed by content application 152, the native application may not provide any native way to display the above addressed collaboration data addressed above. In such embodiments, client collaboration service 160 can detect that a user has opened a content item, and can provide an overlay with additional information for the content item, such as the collaboration data. For example, the additional information can include comments for the content item, a status of the content item, interactions with the content item by other users, etc. Such an overlay can warn a user that changes might be lost because another user is currently editing the content item.

In some embodiments, one or more of the services or storages/databases discussed above can be accessed using public or private application programming interfaces.

Certain software applications can access content storage 142 via an API on behalf of a user account. For example, a software package, such as an application running on client device 150, can programmatically make API calls directly to content management system 110 when a user account provides authentication credentials, to read, write, create, delete, share, or otherwise manipulate content.

A user can utilize a user account to view or manipulate content using a web interface generated and served by web interface service 124. For example, the user can navigate in a web browser to a web address associated with the user account provided by content management system 110. Changes or updates to content in content storage 142 made through web interface 124, such as uploading a new version of a content item, can be propagated back to other client devices associated with the user account. For example, multiple client devices, each with their own client software, can be associated with a single account and content items in the account can be synchronized between each of the multiple client devices.

Client device 150 can connect to content management system 110 on behalf of a user account. A user of the user account can directly interact with client device 150, for example when client device 150 is a desktop or laptop computer, phone, television, internet-of-things device, etc. Alternatively or additionally, client device 150 can act on behalf of the user account without the user having physical access to client device 150, for example when client device 150 is a server.

Some features of client device 150 are enabled by an application installed on client device 150. In some embodiments, the application can include a content management system specific component. For example, the content management system specific component can be a stand-alone application 152, one or more application plug-ins, and/or a browser extension. However, the user can also interact with content management system 110 via a third-party application, such as a web browser, word processor, spreadsheet program, presentation program, source code control tool, etc. that resides on client device 150 and is capable of communicating with content management system 110. In various implementations, client-side application 152 can present a user interface (UI) for a user to interact with content management system 110. For example, the user can interact with the content management system 110 via file system extension 153 integrated with the file system or via a webpage displayed using a web browser application.

In some embodiments, client application 152 can manage and synchronize content for more than one account of content management system 110. In such embodiments, client application 152 can remain logged into multiple accounts and provide normal services for the multiple accounts. In some embodiments, each account can appear as folder in a file system, and all content items within that folder can be synchronized with content management system 110. In some embodiments, client application 152 can include a selector to choose one of the multiple accounts to be the primary account or default account.

While this disclosure presents content management system 110 with specific components, it will be understood by one skilled in the art, that the architectural configuration of system 100 is simply one possible configuration and that other configurations with more or fewer components are possible. Further, a service can have more or less functionality, even including functionality described as being associated with another service. Moreover, features described in this disclosure with respect to a particular embodiment can be combined with features described with respect to another embodiment.

While system 100 is presented with specific components, it will be understood by one skilled in the art, that the architectural configuration of system 100 is simply one possible configuration and that other configurations with more or fewer components are possible.

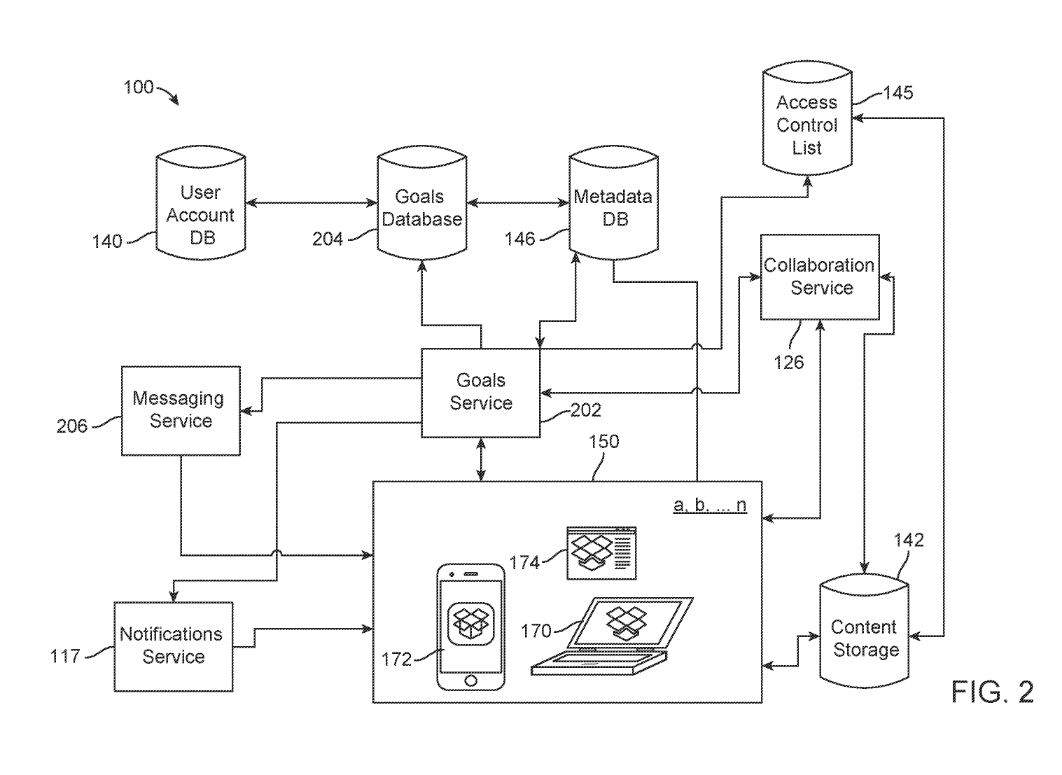

FIG. 2 shows another example view of system 100 including additional components related to the present technology. As addressed above the present technology provides goals service 202 integrated into content management system 110 to provide advantages such as enhanced project management, team member engagement, and team member collaboration.

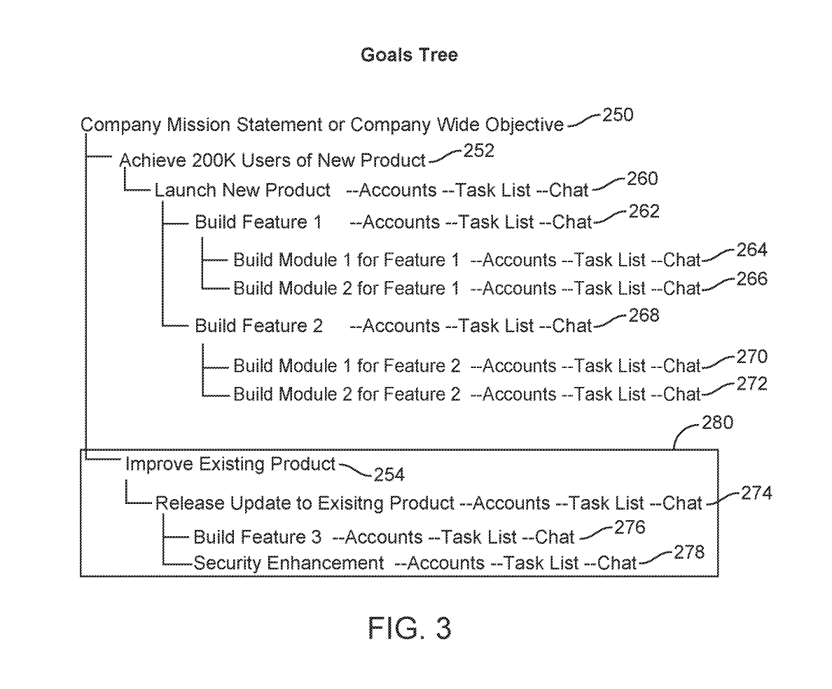

FIG. 2 shows goals service 202. Goals service 202 allows a user account to establish a milestone and associate it with at least one goal, and at least one user account. Specifically, goals service 202 is configured to enforce a data model in which goals>milestone>submilestone. The data model is a hierarchy in which milestones and submilestones are required to be subordinate to a goal. This structure communicates the goal to any user account associated with a milestone, and provides context of how a particular milestone is related to other milestones, submilestones, and goals. FIG. 3 shows an example hierarchy of goals, milestones, and submilestones.

As shown in FIG. 3 there can be a top-level goal 250, which in this example is a company-wide goal or could be the company mission statement. There can also be subordinate goals 252, 254. This immediately shows how each goal fits into the bigger picture of the company's success. Goals are not tasks to be completed by any one person or team. In some instances completion of a goal might not be measurable. Goals are graphically represented in a graphical user interface as text, images, or any other graphically representable item.

FIG. 3 also shows milestones and submilestones 260, 262, 264, 266, 268, 270, 272, 274, 276, 278. Milestones and submilestones are tasks to be completed and they are associated with one or more user accounts. Milestones and submilestones are equivalent, except that submilestones are subordinate to milestones. In some instances, completion of a milestone may be dependent on the completion of a submilestone. For example, FIG. 3 illustrates example milestone 260, the completion of which is dependent on completion of submilestone 262, which is itself dependent on submilestones 264, 266. Milestones and submilestones are graphically represented in a graphical user interface as text, images, or any other graphically representable item.

In addition to the hierarchy defined by the data model, the data model also requires that user accounts are associated with milestones and submilestones. In some embodiments, the data model can also require user accounts to be associated with goals. In some embodiments the data model can require that user accounts be given roles with respect to the goal, milestone, or submilestone to which the user account is associated. Some example roles include owner (creator), responsible (account responsible for completing the milestone or achieving the goal), collaborator, viewer, etc.

Goals service 202 is communicatively coupled to goals database 204, metadata database 146, and access control list 145 for recording goals and milestones, relationships between goals and milestones, user accounts associated with the goals and milestones, access to documents associated with goals and milestones, etc. according to the data model.

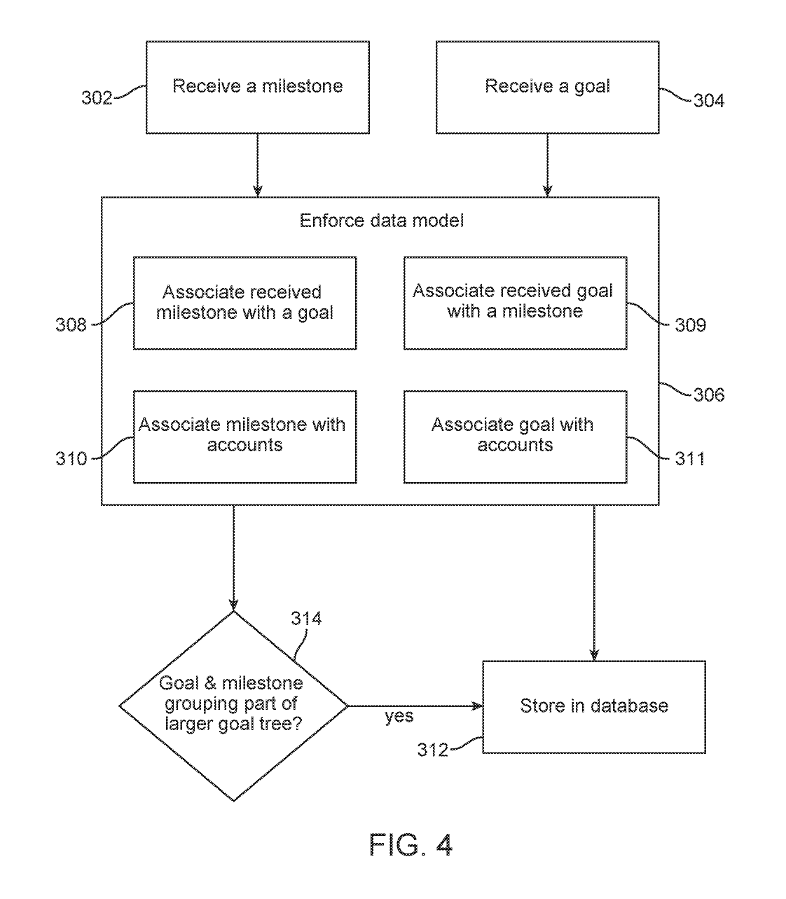

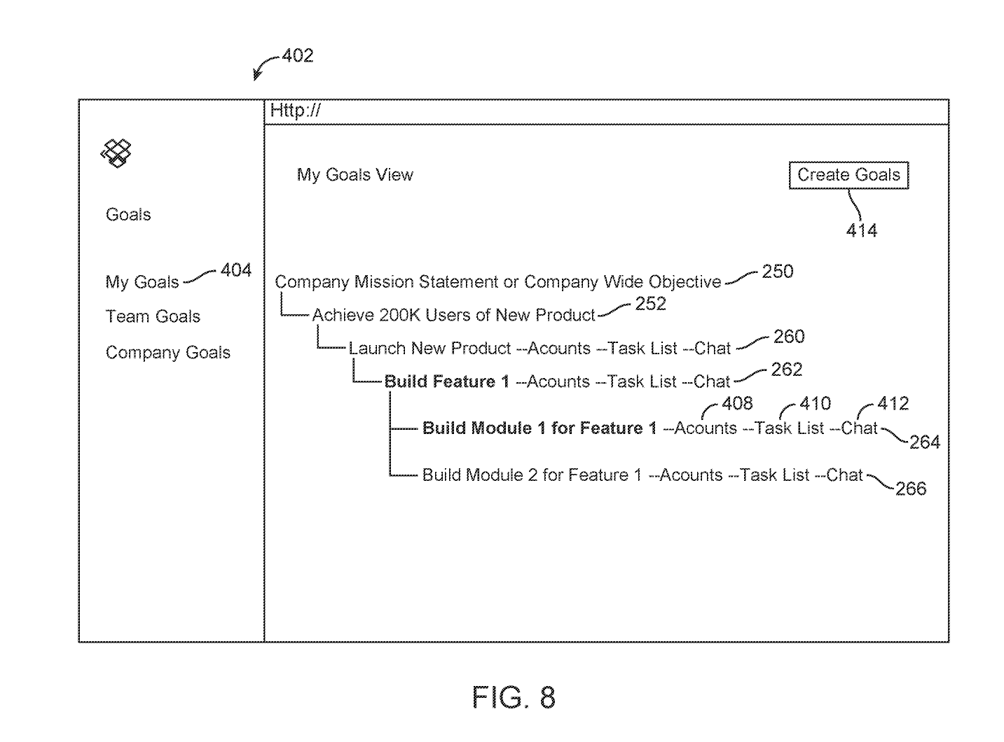

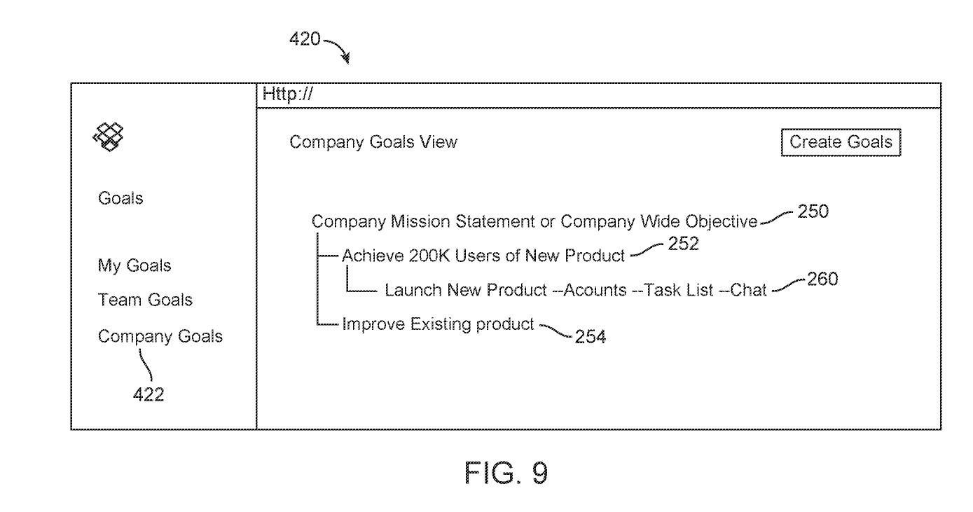

FIG. 4 illustrates an example method for applying the data model. For example, goals service 202 can receive a milestone 302 or goal 304. In some embodiments the milestone or goal is received in a goal service graphical user interface provided by goals service 202 (as shown for example in FIG. 8 and FIG. 9). In some embodiments, text entered into a collaborative content item or interface managed by collaboration service 126 can be labeled as a goal or milestone, and collaboration service 126 can notify goals service 202 of a user account's intention to create a goal or milestone.

Irrespective of whether a goal or milestone is created in a goal service graphical user interface or through a collaborative content item managed by collaboration service 126, goal service 202 can enforce 306 the goals data model addressed above. In some embodiments the data model is enforced 306 by prompting a user account within the goal service graphical user interface or through a collaborative content item managed by collaboration service 126, for required data.

In some embodiments, goal service 202 can automatically populate the data model and ask the user account creating the goal or milestone for confirmation. For example, goals service 202 can associate the user account creating the goal and/or milestone with the goal and/or milestone. Additionally, goals service 202 can learn from user account database 140 or metadata database 146 of accounts assigned to the same team or having the same supervisor and associate each of these accounts to the created goals and/or milestones. In some embodiments in which a content item is associated with a goal and/or milestone, goals service 202 can associate all accounts having access rights noted in access control list 145 with the created goal and/or milestone.

In accordance with the data model, when goals service 202 receives a goal 304 that is not already associated with a milestone, goals service 202 can prompt the user account for at least one milestone to be associated 309 with the received goal. When the goals service 202 receives a milestone 320 that is not already associated with a goal, goals service can prompt the user account for at least one goal to be associated 308 with the received milestone. The milestones or goals that are associated 308, 309 with received goals or milestones, respectively; do not need to be original. They may already exist in goals database 204. When a goal or milestone already exists in the goals database 204, the user account can search the database for the goal. In some embodiments, a field may be provided with a selection list of company goals or milestones.

In addition to creating an association between at least one goal and at least one milestone 308, 309, goals service 202 can prompt for the user account to associate the milestone 310, or goal 311 with user accounts. In some embodiments, the user account creating the goal or the milestone can be the user account associated with the goal and/or milestone. In some embodiments, the user account creating the goal or milestone can associate additional user accounts with the goal and/or milestone.

For example, a first user account associated with first client device 150a can be a project supervisor and can create a milestone that is received by goals service 202. The goals service 202 can prompt first client device 150a for a goal to associate 308 to the milestone and prompt first client device 150a to associate 310 an account to the milestone. The first user account associated with client device 150a can operate client device 150a to identify team member accounts to associate with the milestone. The first user account can optionally be associated 310 with the milestone. The data model can require that at least one user account must be associated 310 with the milestone, but the creating user account (e.g., first user account of project supervisor) does not need to be the associated user account.

After receiving any of the information required by the data model, goals service 202 can store 312 the information regarding the goal or milestone in goals database 204 or other database of system 100. Goals database 204 can store 312 information regarding the relationship of a milestone to a goal to which the milestone is subordinate, and can record user accounts that are associated with the milestone and/or goal.

In some embodiments a particular goal and milestone grouping can also be related to superordinate or subordinate goal. A goal and milestone grouping is a combination of a goal and all milestones subordinate to the goal. For example, as shown in FIG. 3 goal and milestone grouping 280, which includes goal 254 and milestones 274, 276, 278, is subordinate to goal 250. Goals service can determine 314 where a goal and milestone grouping is located within a larger goal tree structure, and can store 312 the relationship of the goal with respect to superordinate or subordinate goals in goals database 204.

In some embodiments, any of the user accounts associated with a milestone can interact with goals service 202 to provide roles with respect to a milestone or a goal. In some embodiments the data model can require a role for at least milestone, wherein a user account can be required to be designated primarily responsible for completion of the milestone. Other user accounts associated with the milestone can be collaborators, or commentators, or be assigned another role. In some embodiments such roles with respect to the milestone or goal can be stored in goals database 204.

In some embodiments, goals service 202 can continue to enforce the data model after creation of the goal or milestone. One challenge that can arise when tasks are assigned to team members is that team members sometimes get removed from a task. Whether the team member leaves an organization altogether, or moves to a new role within the organization, such events can leave tasks unassigned. The present technology alleviates this challenge. When goals service 202 monitors goals and milestones for enforcement with the data model, goals service 202 becomes a tool for managing reassignment of milestones and goals.

Goals service database 204 can receive or detect updates from user account database 140 to learn that a user account has been deactivated, has been removed from a team, etc. Such changes can result in the user account being disassociated with a goal or milestone, or at least their role with respect to the goal or milestone can be modified. Additionally, a team member can affirmatively change a user account's relationship to a goal or a milestone, and the change of role can be stored in goals service database 204.

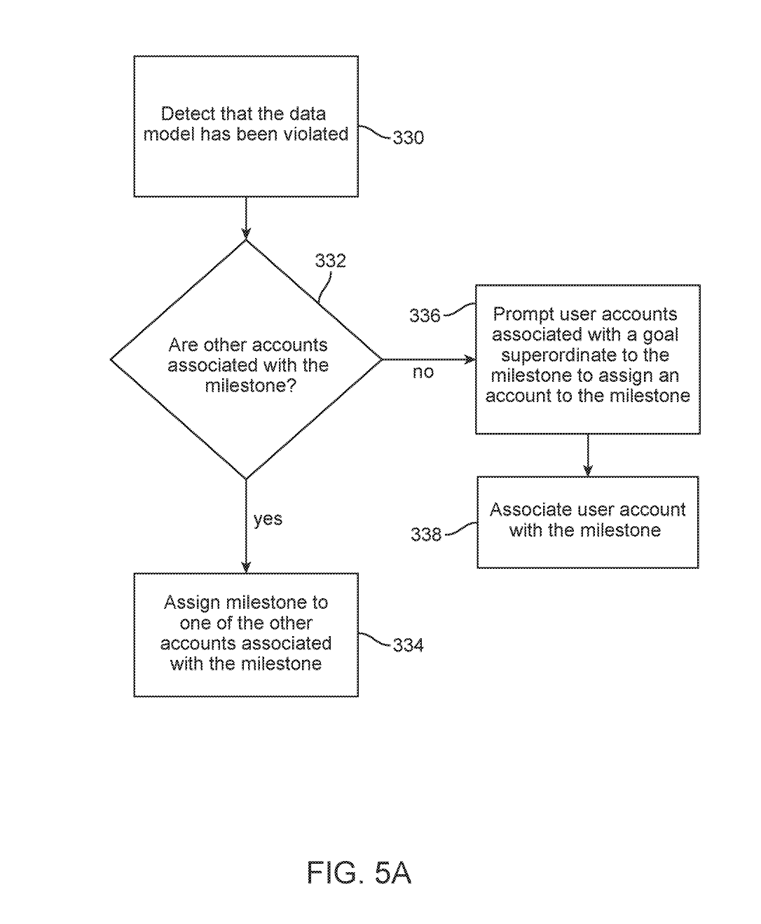

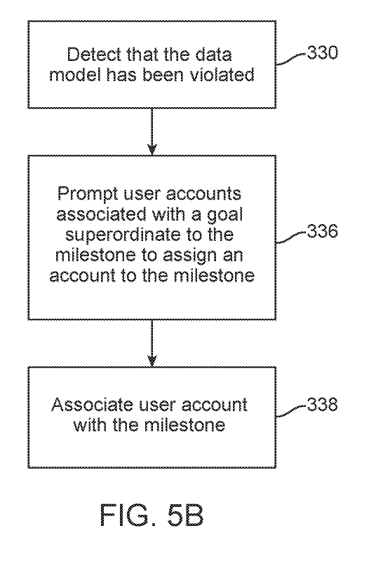

FIGS. 5A and 5B show example methods for maintaining the integrity of the data model after creation of the goal or milestone. Goals service 202 can detect 330 that the data model has been violated. For example, goals service 202 can learn that a role or assignment with respect to a goal or milestone has changed, for example a user account that is responsible for a milestone has become disassociated with milestone.

In embodiments wherein role assignments are required as part of the data model, goals service 202 can determine if any other user accounts are associated 332 with the milestone as illustrated in FIG. 5A. When other user accounts are associated with the milestone, goals service 334 can automatically assign one of the other user accounts to the missing role and notify the other user accounts of the change. When other user accounts are not assigned to the milestone, goals service 202 can prompt 336 user accounts associated with a goal superordinate to the milestone to assign an account to the milestone. Goals service can receive a response to the prompt and associate a user account with the milestone 338 and assign the user account to the missing role.

In embodiments wherein roles are not part of the data model, goals service 202 would only detect 330 that the data model has been violated when no user account is associated with a goal or milestone. In such embodiments goals service 202 can proceed directly to prompting 336 user accounts associated with a goal superordinate to the goal or milestone for which the data model has be violated to associate an account to the milestone as illustrated in FIG. 5B. Goals service can receive a response to the prompt and associate a user account with the milestone 338.

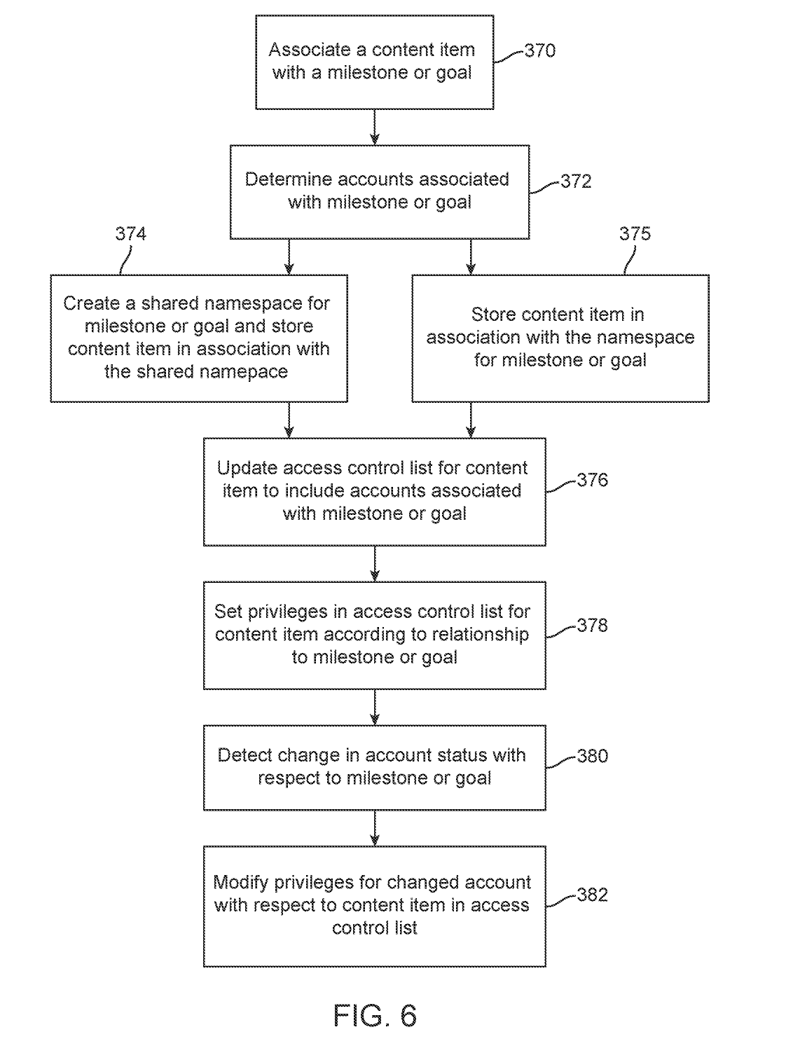

FIG. 6 illustrates an example method of associating a content item with a milestone or goal. In some embodiments achieving a milestone will include producing one or more content items. In such embodiments goals service 202 can receive input from a client device 150 to associate 370 a content item with a milestone or goal. Goals service 202 can determine 372 any user accounts associated with the milestone or goal and can create 374 a shared namespace for the milestone or goal and store the content item in association with the shared namespace. If a namespace was already created, goals service can store 375 the content item in association with the shared namespace.

Additionally, goals service 202 can update 376 access control list 145 to associate the user accounts associated with the goal or milestone with the content item.

In some embodiments, user accounts will have assigned roles in association with the goal or milestone that may correlate to access privileges for a content item. In such embodiments, goals service 202 can set 378 access privileges in access control list 145 to correspond to the assigned roles for each user account in association with the goal or milestone. For example, a user account that is named the responsible party for a milestone can be given edit rights to a content item associated with the milestone. A user account that is the creator (owner) of a milestone can be an owner of the content item. A user account that is a collaborator might be given comment only rights. A user account that is a team supervisor can be given comment rights. A user account that is associated with the milestone by virtue of being a subordinate or superordinate goal or milestone might receive read-only rights. Any of these assigned access rights can be modified through interaction with the access control list 145.

In some embodiments goal service 202 can detect 380 that there is a change in account status with respect to a milestone or goal. In some embodiments this detection 380 is similar to detection 330 that the data model has been violated. In response to detection 380, goals service 202 can modify 382 access privileges in access control list 145 for the changed account with respect to the associated content item. In some embodiments, goals service can prompt one or more user accounts associated with the task or milestone to which the content item is associated and prompt the user account(s) to adjust or confirm access privileges.

In some embodiments, goals module 202 can link (see e.g., 412 in FIG. 8) a milestone with a communications platform such as email, messaging service 206, or notifications service 117. Messaging service 206 can be a communication tool for exchanging messages with user accounts. In some embodiments messaging service can create and save messaging threads organized around documents, topics, milestones, etc. In some embodiments messaging service can also be useful for exchanging content items. Examples of tools similar to messaging service 206 can include SLACK by Slack Technologies, Inc., SPARK by Cisco Technologies, Inc., LYNC, by Microsoft Corp., GOOGLE HANGOUTS, by Google, Inc. As addressed above with respect to FIG. 1, notifications service 117 can be a push notification service.

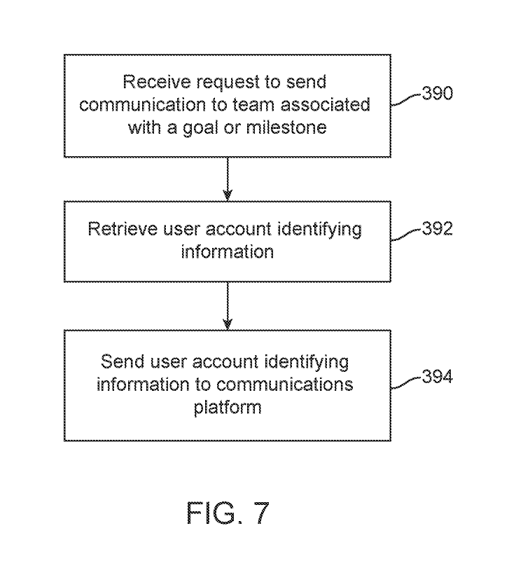

FIG. 7 shows an example method for sending a communication using a communications platform. Goals service 202 can receive a selection of graphical user interface control 410 such as that shown in FIG. 8, or be otherwise notified that a user account requests 390 to utilize a communications platform such as email, messaging service 206, or notifications service 117 to send a communication to the team associated with a milestone, such as milestone 264. In response to receiving 390 the request to send a communication to the team, goals service 202 can retrieve 392 user account identifying information from goals database 204, and can send 394 the account identifying information to the communications platform to automatically address a communication. In the case of email, email addresses are prepopulated along with a subject line including the name of the milestone into an email message. In the case of a notification addresses are prepopulated into notification composing interface. In the case of messaging service, addresses are prepopulated into notification composing interface and a new thread is created with the title of the milestone—or if a thread already exists, the thread can be opened.

In some embodiments, goals service 202 can automatically send communications relevant to goals and milestones to user accounts associated with the goals or milestones. Goals services 202 keeps teams in sync in an automated fashion by integrating communication methods with the rest of goals service 202. For example goals service can be integrated with email, mobile push notifications, desktop notifications, SMS etc. Goals service 202 can use such communication methods to automatically communicate with assigned team members if a milestone becomes un-owned, as addressed above. Goals service 202 can also use such communication methods to inform a user that they are responsible for a goal or milestone. Goals service 202 can also use such communication methods to inform team members about progress with respect to achieving the goal or milestone by automatically pushing notifications pertaining to access and editing of documents in a namespace associated with the goal or milestone. User accounts are an integral enforced part of the data model and communication is integrated in the system, and this ensures adequate communication among people on teams associated with goals and milestones.

FIG. 8 shows an example goals service graphical user interface. FIG. 8 shows “My Goals View” graphical user interface 402 for displaying goals and milestones for a logged in user account. “My Goals View” graphical user interface 402 includes a sidebar with links for “My Goals” 404, “Team Goals”, and “Company Goals.” Each of these links is clickable to navigate to different sub-views of the goals tree illustrated in FIG. 3. “My Goals View” graphical user interface 402 is the result of a navigating to the My Goals page associated with “My Goals” link 404. This user account is associated with milestones 260, 262, 264, 266. Due to the user account's association with these milestones, they are also associated with superordinate goals 250, 252. As such this view provides the user account with a view of how their milestones fit into the context of the company, which can contribute to better engagement by the team member. In “My Goals View” graphical user interface 402, milestones 262 and 264 are bolded or otherwise distinguished to identify milestones for which the user account is the primary responsible user account.

FIG. 9 shows another example goals service graphical user interface. FIG. 9 shows “Company Goals View” graphical user interface 420, which can be reached by navigating to “company goals” link 422. “Company Goals View” graphical user interface 420 can present a subset of the goals tree illustrated in FIG. 3 showing all goals in the tree: goals 250, 252, 254, 260. This view can provide another contextual view to understand how the goal to which the user account is associated fits in the context of all of the other company goals.

In some embodiments, graphical user interfaces 402 and 420 can be further filtered to show the most relevant goals to the view so as to not overwhelm the user viewing the interface. As large companies could have thousands of goals, it might be preferable to show only a limited number of goals, or allow a user account to filter the amount of detail shown in graphical user interfaces 402 and 420.

FIG. 8 further shows links associated with milestones such as link 408 for displaying user accounts associated with milestone 264, link 410 linking to a task list associated with milestone 264, and link 412 for launching a communication platform (as addressed in FIG. 7) associated with milestone 264. In some embodiments usernames or pictures representing respective user accounts can replace link 410.

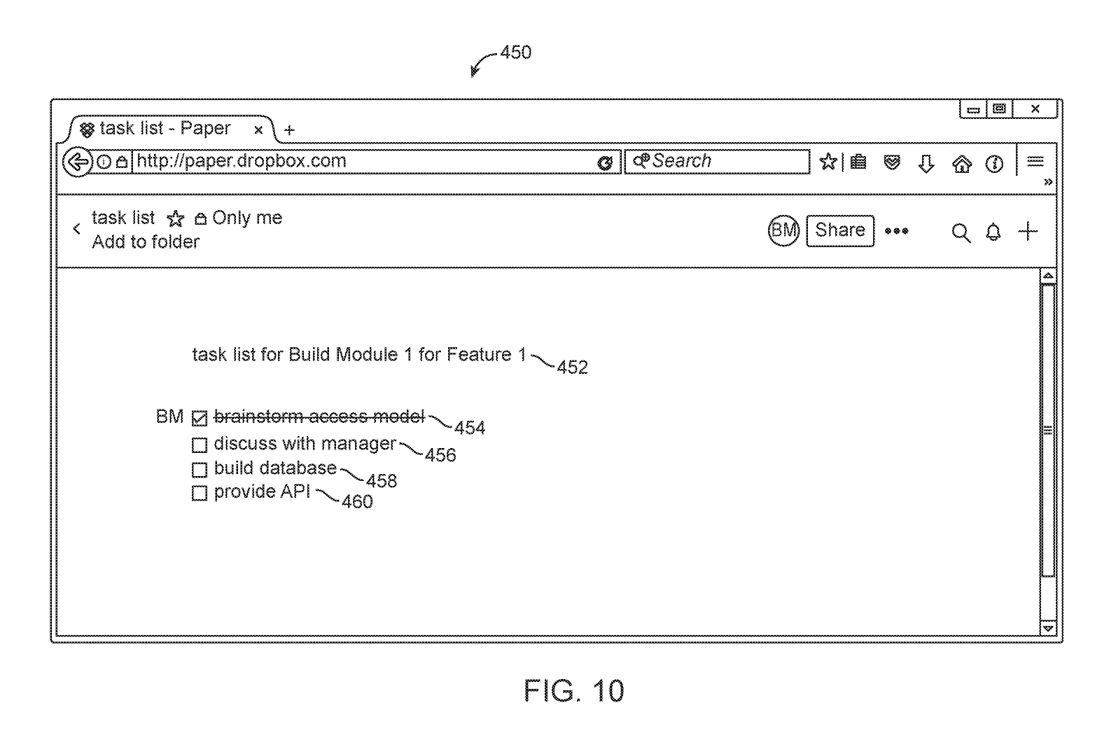

Link 410 can link the milestone to a related task list. FIG. 10 illustrates an example task list linked to a milestone. When a user selects link 410, user account request goals service 202 to direct user account to a collaboration content item hosted by collaboration service 126 that includes a list of tasks related to milestone 264. While collaboration content items are web browser hosted documents that are configured to be shared and allow simultaneous collaboration on the collaboration content item, collaboration content items are not required to be shared.

FIG. 10 shows collaboration content item 450 presenting task list 452. Task list 452 can be a checklist of tasks to be performed to complete a milestone. Task list 452 is linked to milestone 264, and includes tasks: “brainstorm access model” 454, “discuss with manager” 456, “build database” 458, and “provide API” 460. As each task is completed they can be checked and crossed out. The tasks do not need to be sequential. In some embodiments marking a milestone as completed in “My Goals View” graphical user interface 402 can result in task list 452 automatically marking each task as completed.

Returning to FIG. 8, “My Goals View” graphical user interface 402 also shows “Create Goals” button 414. Selection of button 414 can begin the process of creating a new goal or milestone and can initiate the method shown in FIG. 4.

Throughout this description of the present technology, reference has been made to services and database such as those shown in FIG. 1 and FIG. 2. It should be appreciated that these services and databases can perform overlapping functions, can be combined into fewer services or database, or split into additional services or databases.

Throughout this description of the present technology, reference is made to goals and milestone. In some instances, for convenience and clarity of explanation only a goal or only a milestone may be described. However, persons of ordinary skill int eh art will appreciate that the functions associated with goals and functions can be equivalent except where a distinction is explicitly made.

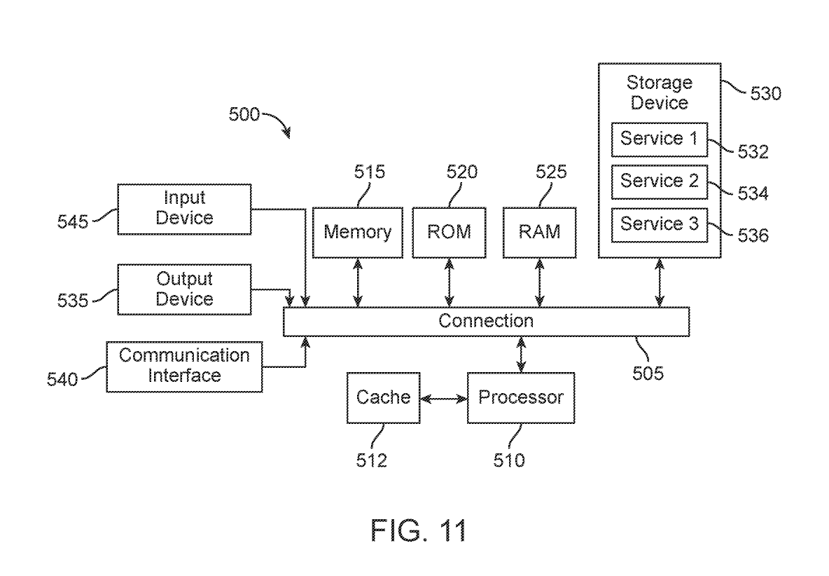

FIG. 11 shows an example of computing system 500 in which the components of the system are in communication with each other using connection 505. Connection 505 can be a physical connection via a bus, or a direct connection into processor 510, such as in a chipset architecture. Connection 505 can also be a virtual connection, networked connection, or logical connection.

In some embodiments computing system 500 is a distributed system in which the functions described in this disclosure can be distributed within a datacenter, multiple datacenters, a peer network, etc. In some embodiments, one or more of the described system components represents many such components each performing some or all of the function for which the component is described. In some embodiments, the components can be physical or virtual devices.

Example system 500 includes at least one processing unit (CPU or processor) 510 and connection 505 that couples various system components including system memory 515, such as read only memory (ROM) and random access memory (RANI) to processor 510. Computing system 500 can include a cache of high-speed memory connected directly with, in close proximity to, or integrated as part of processor 510.

Processor 510 can include any general purpose processor and a hardware service or software service, such as services 532, 534, and 536 stored in storage device 530, configured to control processor 510 as well as a special-purpose processor where software instructions are incorporated into the actual processor design. Processor 510 may essentially be a completely self-contained computing system, containing multiple cores or processors, a bus, memory controller, cache, etc. A multi-core processor may be symmetric or asymmetric.

To enable user interaction, computing system 500 includes an input device 545, which can represent any number of input mechanisms, such as a microphone for speech, a touch-sensitive screen for gesture or graphical input, keyboard, mouse, motion input, speech, etc. Computing system 500 can also include output device 535, which can be one or more of a number of output mechanisms known to those of skill in the art. In some instances, multimodal systems can enable a user to provide multiple types of input/output to communicate with computing system 500. Computing system 500 can include communications interface 540, which can generally govern and manage the user input and system output. There is no restriction on operating on any particular hardware arrangement and therefore the basic features here may easily be substituted for improved hardware or firmware arrangements as they are developed.

Storage device 530 can be a non-volatile memory device and can be a hard disk or other types of computer readable media which can store data that are accessible by a computer, such as magnetic cassettes, flash memory cards, solid state memory devices, digital versatile disks, cartridges, random access memories (RAMs), read only memory (ROM), and/or some combination of these devices.

The storage device 530 can include software services, servers, services, etc., that when the code that defines such software is executed by the processor 510, it causes the system to perform a function. In some embodiments, a hardware service that performs a particular function can include the software component stored in a computer-readable medium in connection with the necessary hardware components, such as processor 510, connection 505, output device 535, etc., to carry out the function.

For clarity of explanation, in some instances the present technology may be presented as including individual functional blocks including functional blocks comprising devices, device components, steps or routines in a method embodied in software, or combinations of hardware and software.

Any of the steps, operations, functions, or processes described herein may be performed or implemented by a combination of hardware and software services or services, alone or in combination with other devices. In some embodiments, a service can be software that resides in memory of a client device and/or one or more servers of a content management system and perform one or more functions when a processor executes the software associated with the service. In some embodiments, a service is a program, or a collection of programs that carry out a specific function. In some embodiments, a service can be considered a server. The memory can be a non-transitory computer-readable medium.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can comprise, for example, instructions and data which cause or otherwise configure a general purpose computer, special purpose computer, or special purpose processing device to perform a certain function or group of functions. Portions of computer resources used can be accessible over a network. The computer executable instructions may be, for example, binaries, intermediate format instructions such as assembly language, firmware, or source code. Examples of computer-readable media that may be used to store instructions, information used, and/or information created during methods according to described examples include magnetic or optical disks, solid state memory devices, flash memory, USB devices provided with non-volatile memory, networked storage devices, and so on.

Devices implementing methods according to these disclosures can comprise hardware, firmware and/or software, and can take any of a variety of form factors. Typical examples of such form factors include servers, laptops, smart phones, small form factor personal computers, personal digital assistants, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

What is claimed is:

1. A system comprising:
a goals service, the goals service configured to enforce a data model to at least one goal and at least one milestone, the at least one goal and at least one milestone being represented as a first graphically representable item, wherein the data model requires:
when the first graphically representable item is designated a first goal of the at least one goal, require a first milestone of the at least one milestone to be identified, the first milestone being associated with at least one user account, the first milestone being subordinate to the first goal;
when the first graphically representable item is designated the first milestone of the at least one milestone, require at least one user account to be associated with the first milestone, and require the first milestone be associated with the first goal of the at least one goal to which the first milestone is subordinate; and
a goals database, the goals database configured to store the first milestone, the at least one user account associated with the milestone, and the goal to which the milestone is subordinate.

2. The system of claim 1, wherein the goals service is configured to enforce the data model to a second goal of the at least one goal, the second goal being subordinate to the first goal, and the second goal being associated with at least one second milestone of the at least one milestone subordinate to the second goal.

3. The system of claim 1, wherein the data model requires that the first goal be associated with at least one user account, and the goals database is configured to store the at least one user account associated with the first goal.

4. The system of claim 3, wherein the goals service is configured to send data to a client device identifying the at least one user account associated with the milestone, and the at least one user account associated with the first goal, to identify members of a team, the team including all accounts of the at least one user account responsible for achieving the first goal.

5. The system of claim 4, comprising:
a messaging service, the messaging service configured to receive from the goals service, the accounts of the team, and to send a communication to the team related to the first goal.

6. The system of claim 4 comprising:
a content storage configured to store a first content item, the first content item being associated with the first goal;
an access control list configured to store the accounts of the team in association with the first content item.

7. The system of claim 6, wherein the access control list is modified so that each account from the at least one user account associated with the milestone is no longer permitted access to the first content item,
the goals service being configured to enforce the data model by prompting user accounts associated with a goal superordinate to the milestone to assign a replacement user account to be associated with the milestone.

8. The system of claim 6, wherein the at least one user account associated with the first milestone includes a first user account and a second user account, the goals service being configured to provide roles with respect to the goal and store the roles in the access control list, whereby the first user account is assigned the owner of the first milestone and is the owner of the first content item, and the second user account is a collaborator on the first milestone and is given edit rights to the first content item.

9. The system of claim 8, wherein the at least one user account associated with the first goal includes a third user account, the goals service being configured to assign the third user account as a team supervisor, and is given comment rights to the first content item.

10. The system of claim 1, comprising:
a collaboration service configured to host a collaboration content item, the collaboration content item including a task list, and the first milestone of the at least one milestone being linked to the collaboration content item including the task list.

11. The system of claim 1, comprising:
a sharing service, the sharing service configured to create a shared namespace for the first milestone, wherein the shared namespace is accessible to the at least one user account associated with the milestone, when the at least one user account associated with the milestone includes a first user account and a second user account, and to add a first content item associated with the first milestone to the shared namespace.

12. A non-transitory computer readable medium comprising instructions, the instructions, when executed by a computing system, cause the computing system to:
receive a first milestone by a goals service;
apply a data model to the first milestone, the data model including instructions to:
receive at least a one user account to associate to the first milestone, and receive at least a first goal;
associate the first milestone to the at least the first goal, the first milestone being subordinate to the at least one goal; and
store the first milestone, the at least one user account associated with the milestone, and the goal to which the milestone is subordinate.

13. The non-transitory computer readable medium of claim 12, wherein the first milestone and the at least the first goal are included in a chain of goals, the first goal being subordinate to a second goal, at least one user account associated with the milestone is a first account, the first goal associated with a second user account, and the second goal associated with a third user account.

14. The non-transitory computer readable medium of claim 13, wherein the first goal being represented as a first graphically representable item, and wherein the instructions are effective to:
receive a selection of the first graphically representable item, and receive an instruction in connection with the selection of the first graphically representable item to send a message to user accounts associated with the first goal and subordinate milestones.

15. The non-transitory computer readable medium of claim 13, wherein the second goal being represented as a second graphically representable item, and wherein the instructions are effective to:
receive a selection of the second graphically representable item, and receive an instruction in connection with the selection of the second graphically representable item to send a message to user accounts associated with the second goal and subordinate goals and milestones.

16. The non-transitory computer readable medium of claim 12, wherein the instructions are effective to:
associate a content item with the first milestone; and
automatically provide access rights to the at least a first account and any other account associated with the first milestone.

17. The non-transitory computer readable medium of claim 16, wherein the instructions are effective to:
determine that the first account is no longer associated with the first milestone; and
prompt any other account associated with the first milestone, or an account associated with the goal to which the milestone is subordinate to designate a new account to be associated with the first milestone.

18. A method comprising:
receiving a first milestone by a goals service;
applying a data model to the first milestone, the data model requiring at least a one user account to be associated to the first milestone, and at least a first goal to be associated to the first milestone, the first milestone being subordinate to the at least one goal; and
storing the first milestone, the at least one user account associated with the milestone, and the goal to which the milestone is subordinate.

19. The method of claim 18, wherein the first milestone and the at least the first goal are included in a chain of goals, the first goal being subordinate to a second goal, at least one user account associated with the milestone is a first account, the first goal associated with a second user account, and the second goal associated with a third user account.

20. The method of claim 18, wherein the first goal being represented as a first graphically representable item, the method comprising:
receiving a selection of the first graphically representable item; and
receiving an instruction in connection with the selection of the first graphically representable item to send a message to user accounts associated with the first goal and subordinate milestones.
